(19) United States
(12) Patent Application Publication
(10) Pub. No.: US 2014/0304032 A1
(43) Pub. Date: Oct. 9, 2014

(54) METHOD AND SYSTEM FOR IMPLEMENTING DISPLAY OF REVENUE OPPORTUNITIES

(71) Applicant: Oracle International Corporation, Redwood Shores, CA (US)

(72) Inventors: Kara MITCHELL, Littleton, CO (US); Paul HOUTKOOPER, Aurora, CO (US); Aaron JOHNSON, Castle Pines, CO (US); Karthikeyan BALASUBRAMANIAN, Aurora, CO (US)

(73) Assignee: ORACLE INTERNATIONAL CORPORATION, Redwood Shores, CA (US)

(21) Appl. No.: 14/248,323

(22) Filed: Apr. 8, 2014

Related U.S. Application Data
(60) Provisional application No. 61/809,614, filed on Apr. 8, 2013.

(51) Int. Cl. G06Q 30/02

(52) U.S. Cl. CPC G06Q 30/0201
USPC 705/7.29

(57) ABSTRACT

An improved approach is described for performing analysis and display of revenue opportunities for large data sets. A user interface is provided to the CSR which provides real-time data relevant to the sales process. The information includes, for example, up-selling opportunities, cross-selling opportunities, profitability analysis, and/or fulfillment analysis.

### CROSS-REFERENCE TO RELATED APPLICATIONS

The present application claims the benefit of priority to U.S. Provisional Patent Application Ser. No. 61/809,614, entitled “Method and System for Implementing Display of Revenue Opportunities” (Attorney Docket No. ORA130843-US-PSP), filed Apr. 8, 2013, which is hereby incorporated by reference in its entirety.

### BACKGROUND AND SUMMARY

Companies with customer service centers often wish to take advantage of their customer interactions to drive additional revenue. For example, Customer Service Representatives (CSRs) can help drive revenue for a company by providing helpful recommendations during an order process for additional sales opportunities or by providing high quality levels for the customer experience.

Conventionally, the task of recommending higher quantity levels for products or suggesting additional products to the customer is very cumbersome. The CSRs could perform this process by looking through multiple price lists to determine promotional discounts, export information to a spreadsheet to perform calculations, or ask the IT department to create reports with the information they want. Depending on the complexity of the discount schedules and the number of discounts that apply to a product, it can be difficult to determine what additional discounts could apply if the customer purchased additional quantities.

Performing this process while on the phone with a customer is particularly time consuming and error prone. As is evident, managing multiple price lists and promotions makes it difficult for CSRs to recommend higher quantities, related products, or promotional discounts to drive sales. In addition, it is not normally feasible for companies to evaluate this type of information in real-time during order capture, due to heavy I/O and serialized processing.

Consumer-driven shopping sites may include automated product recommendations to consumers during the consumer's shopping session on a given site. However, these consumer-driven sites typically only include very rudimentary functionality to provide cross-sell and up-sell information, and indeed are so generalized that they are applicable to all consumers, without regard to any particular aspect or attributes of a given customer. Furthermore, this type of functionality on consumer-driven web sites is not robust enough to handle the massive amount of financial data, customer data, and deals/promotions variability that must be provided by an enterprise class application.

To address these problems, the present disclosure is directed to an improved approach for performing analysis and display of revenue opportunities for large data sets. According to some embodiments, the invention operates by presenting a user interface to the CSR which provides real-time data relevant to the sales process. The information includes, for example, up-selling opportunities, cross-selling opportunities, profitability analysis, and/or fulfillment analysis. The analysis can be performed with controllable levels of granularity and specificity for the analysis.

This approach provides visibility into real-time product suggestions during the sales order entry process, which gives the CSR information to drive additional sales for his/her company. With CSRs up-selling and cross-selling during order entry, both sales volumes and revenue are likely to increase.

In addition, insight into large volumes data in real-time enables CSRs to leverage sales opportunities and proactively adapt to changing sales conditions during order capture. The large volume of data is compiled, summarized, and displayed for the CSR to make recommendations to the customer very quickly, instead of using error prone, manual processes to locate information which takes excessive amounts of time and can require return calls to the customer. As a result, enterprises can increase the efficiency of the order entry process, create and enhance up-sell and cross-sell revenue opportunities, and reduce error prone manual tasks and dissatisfied customers.

Further details of aspects, objects, and advantages of the invention are described below in the detailed description, drawings, and claims. Both the foregoing general description and the following detailed description are exemplary and explanatory, and are not intended to be limiting as to the scope of the invention.

### BRIEF DESCRIPTION OF THE DRAWINGS

The drawings illustrate the design and utility of embodiments, in which similar elements are referred to by common reference numerals. These drawings are not necessarily drawn to scale. In order to better appreciate how the above-recited and other advantages and objects are obtained, a more particular description of the embodiments will be rendered which are illustrated in the accompanying drawings. These drawings depict only exemplary embodiments and are not therefore to be considered limiting of the scope of the claims.

FIG. 1 shows an architecture of a system for performing analysis and display of revenue opportunities in accordance with some embodiments.

FIG. 2A illustrates a flowchart of an approach for performing up-selling analysis in accordance with some embodiments.

FIG. 2B illustrates a system for performing up-selling analysis in accordance with some embodiments.

FIG. 2C illustrates a flowchart of an approach for retrieving up-sell content in accordance with some embodiments.

FIGS. 3A-B illustrate an example user up-sell interface in accordance with some embodiments.

FIG. 4A illustrates a flowchart of an approach for performing cross-selling analysis in accordance with some embodiments.

FIG. 4B illustrates a system for performing cross-selling analysis in accordance with some embodiments.

FIG. 4C illustrates a flowchart of an approach for retrieving cross-sell content in accordance with some embodiments.

FIG. 5 illustrates an example cross-sell user interface in accordance with some embodiments.

FIG. 6 illustrates a flowchart of an approach for performing allocation analysis in accordance with some embodiments.

FIG. 7 illustrates an example user interface to display allocation analysis data in accordance with some embodiments.

FIG. 8 illustrates a flowchart of an approach for performing profitability analysis in accordance with some embodiments.

FIGS. 9-11 illustrate example interfaces for presenting profitability analysis in accordance with some embodiments.

FIG. 12 depicts a computerized system on which an embodiment of the invention can be implemented.

### DETAILED DESCRIPTION

The present disclosure is directed to an improved approach for performing analysis and display of revenue opportunities. According to some embodiments, the invention operates by presenting a user interface to the CSR which provides real-time data relevant to the sales process. The information includes, for example, up-selling opportunities, cross-selling opportunities, profitability analysis, and/or fulfillment analysis.

This approach provides a transformational solution that addresses the previously-described business problems that exist within large, complex organizations. The invention takes advantage of historical sales information and configured sales/marketing information to display revenue opportunities dynamically during order capture. This approach enables CSRs to guide customers to the right product purchases quickly and easily to capture the optimal order for the customer. Therefore, the invention can be used to reduce manual processes, increase top line revenue, improve revenue and profit margins, generate higher customer satisfaction, and reduce system setup and maintenance.

Various embodiments are described hereinafter with reference to the figures. It should be noted that the figures are not drawn to scale and that the elements of similar structures or functions are represented by like reference numerals throughout the figures. It should be noted that the figures are only intended to facilitate the description of the embodiments. They are not intended as an exhaustive description of the invention or as a limitation on the scope of the invention. In addition, an illustrative embodiment need not have all the aspects or advantages shown. An aspect or an advantage described in conjunction with a particular embodiment is not necessarily limited to that embodiment and can be practiced in any other embodiments even if not so illustrated. Also, reference throughout this specification to “some embodiments” or “other embodiments” means that a particular feature, structure, material, or characteristic described in connection with the embodiments is included in at least one embodiment. Thus, the appearances of the phrase “in some embodiment” or “in other embodiments” in various places throughout this specification are not necessarily referring to the same embodiment or embodiments.

For the purposes of explanation, one or more embodiments may be illustratively described with reference to customer relations management (“CRM”) applications and/or enterprise resource planning (“ERP”) applications. It is noted, however, that the invention may be applied to other types of enterprise applications as well, and is not to be limited to CRM or ERP applications unless explicitly claimed as such. In addition, for the purposes of the specification, the terms item and product may be used interchangeably, and may refer to physical products, non-physical products, or services.

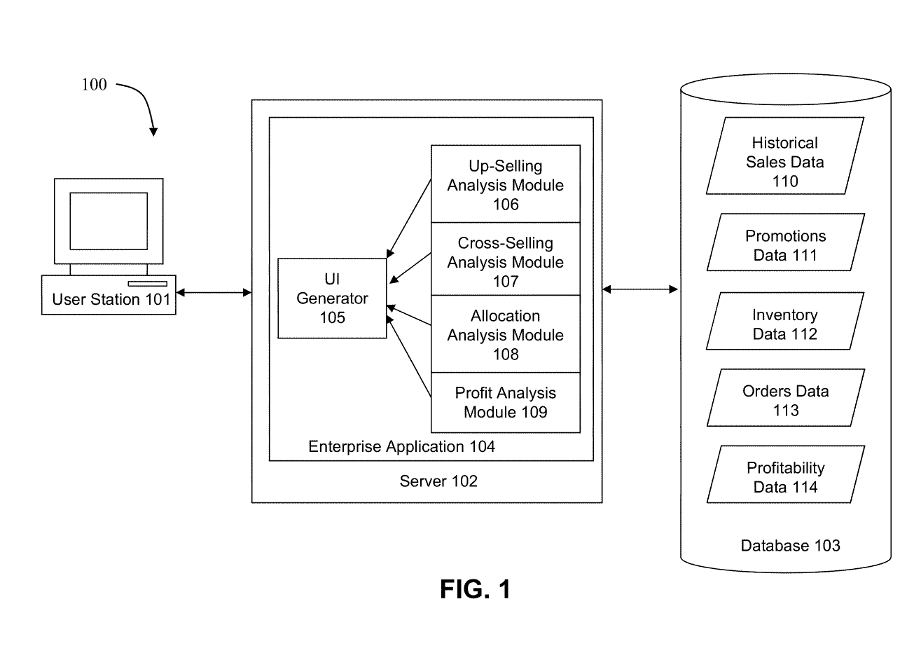

FIG. 1 illustrates an example system 100 for performing analysis and display of revenue opportunities in accordance with some embodiments. The system 100 includes one or more users at one or more user stations 101 that operate the system to operate an enterprise application 104 on an enterprise server 102. The user station 101 comprises any type of computing station that may be used to operate or interface with the applications in the system. Examples of such user stations include for example, workstations, personal computers, or remote computing terminals. User stations may also include mobile devices, such as smartphones, tablets, or touchscreen devices. The user station 101 comprises a display device, such as a display monitor, for displaying a user interface to users at the user station. The user station 101 also comprises one or more input devices for the user to provide operational control over the activities of the system, such as a mouse, keyboard, or touchscreen to manipulate in a graphical user interface to generate user inputs (e.g., by manipulating a cursor or pointing object in the graphical user interface).

The data operated upon by the system 100 may be stored in a computer readable storage device 103 (hereinafter, database 103). The database 103 may comprise any combination of hardware and software that allows for ready access to the data that is located at the computer readable storage device. For example, the database 103 could be implemented as computer memory operatively managed by an operating system. The database 103 could also be implemented as an electronic database system having storage on persistent and/or non-persistent storage. The data operated upon in the system 100 includes, for example, historical sales data 110, promotions/pricing deals data 111, inventory data 112, data about pending sales orders 113, and/or profitability data 114.

The enterprise application 104 comprises any business application or suite of business applications that provide visibility and control over various aspects of the business. These applications can include, without limitation, CRM applications, ERP applications, supply chain management applications, and other applications dealing with various finance, accounting, manufacturing, and/or distribution functions, to name but a few examples. Exemplary enterprise application suites include, without limitation, Oracle Fusion, Oracle eBusiness Suite and JD Edwards Enterprise One, all of which are available from Oracle Corporation of Redwood Shores, Calif.

The enterprise application 104 comprises a user interface generator 105 that generates interface display elements visible to the CSR at user station 101 during the order processing. The additional display information provides the ability for the user, for example, to view additional item and quantity suggestions during sales order entry.

The additional content for the user interface can correspond to any additional content producible by the enterprise application system. One type of additional content comprises up-sell opportunities generated by an up-sell analysis module 106. A second type of additional content comprises cross-sell opportunities generated by a cross-sell analysis module 107. A third type of content comprises allocation analysis data may be used by an allocation analysis module 108 to provides information about fulfillment/allocation issues that may apply to the order. A fourth example type of content comprises profitability data that can be used by a profit analysis module 109 to assist the CSR in understanding the profit impact of the sales order.

The modification of the user interface makes the additional information available for selection, but the CSR is not required to view or to take action upon the additional content. In some embodiments, the additional UI content is provided in one or more separate tabs within a user interface screen, where the tab is selectable to display to the additional content. For example, for the additional cross-sell or up-sell content, additional item and quantity recommendations for the sales order are provided in the tabbed interface. A Line Advisor tab can be provided which displays line up-selling recommendations. An Order Advisor tab can be provided which displays order level cross-selling recommendations. Visual indicators can be provided for order up-sell opportunities.

### Up-Sell

In some embodiments, the up-selling analysis process produces at least two components that can be displayed in the user interface, e.g., in two separate grid displays. Any number of items can be configured for display in the grid display, e.g., where up to 5 items are displayed for each grid.

The first component is for “Preferred Items”, which are up-sells to another item based on a relationship to the item ordered (e.g., a higher profit margin item). In some embodiments, the preferred items are configured using predefined relationships between items. The relationships are defined and configured in the enterprise system to facilitate the analysis. The interface is configured to provide a view of the upsell item(s), description, price, and quantity.

The second component is for “Quantity Increases”, which are up-sells to a higher quantity level to provide the customer with better pricing. This type of analysis operates by evaluating an adjustment schedule for quantity breaks. The interface is configured to provide a view of quantity, unit of measure, price, and extended price for these upsell items. In some embodiments, an icon can be displayed if a free good is associated with the quantity increase.

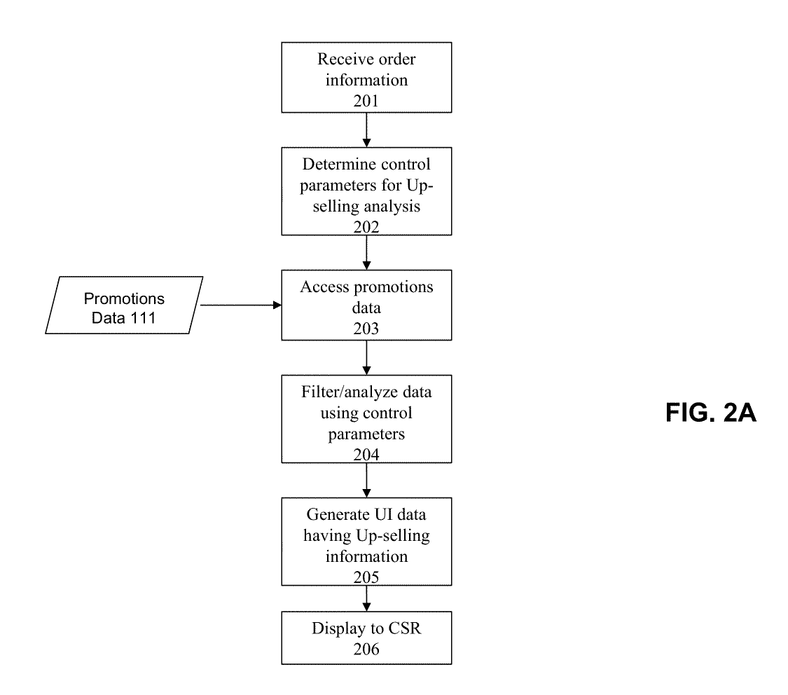

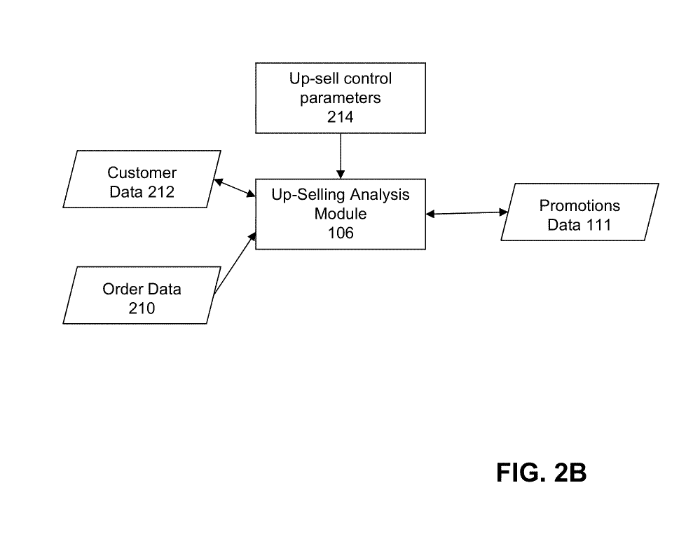

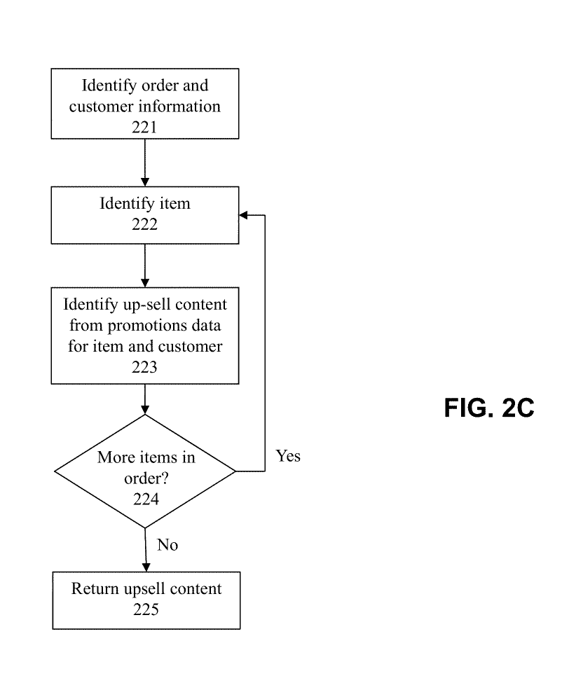

FIG. 2A shows a flowchart of an approach to implement the up-sell analysis. At 201, information about the order is received. This may occur when the CSR enters a sales order into a user interface at an enterprise application. The order information may include, for example, ordered items, item prices, and quantity information.

At 202, control parameters for the up-sell analysis that is to be performed may be identified. This permits a high level of customization regarding the analysis that is performed. For example, the scope of consideration can be adjusted to any level of granularity with regards to the entity, customer, or group of entities under consideration. Therefore, the analysis can be performed with respect to an individual customer, for a group of customers, or for applicability to everyone.

Various ways can be implemented to define the scope of coverage for the analysis, which can be used to implement criteria to filter possible opportunities for display. Examples of such criteria include: (a) geography or region; (b) industry type; (c) customer type (e.g., individual, wholesaler, retailer, distributor, etc.); (d) customer size. Groupings can also be defined to include one or more customers, e.g., by configuring a distribution group or group ID that is common to a group of customers. Certain up-sell opportunities or promotions may be directed towards a particular customer or group of customers (e.g., a promotion that applies to customers located in New York), while others may be of general applicability that may apply to all customers. Configuring the scope of coverage may determine which promotions are retrieved for analysis and for generating up-sell opportunities. For example, in some embodiments different promotions may be retrieved for different customers even if they are ordering the same items, depending upon different attributes used to define the scope of coverage for the analysis (e.g., a customer located in New York ordering a particular item may receive different promotions from a customer in California ordering the same item, if customer location is specified as a criterion in the scope of coverage).

This ability to define the scope of coverage for the analysis is a great advantage over conventional consumer-driven shopping sites that may include automated product recommendations to consumers during the consumer's shopping session, since the consumer-driven sites typically only include very rudimentary functionality for recommendations that are uniformly provided for every customer, without regard to any particular aspect or attributes of a given customer.

In some embodiments, the control parameters may be a default set of control parameters specified during setup of the up-sell analysis module. In some embodiments, control parameters may be entered by the CSR at a user interface when entering an order and/or requesting up-sell opportunities.

At 203, a database of available promotions and/or deals (hereinafter, promotions data 111) is accessed. The promotions data 111 may comprise up-sell opportunities and promotions for both the “preferred items” and “quantity increase” types of up-sells.

At 204, promotions data 111 is filtered to remove any inapplicable content (e.g., promotions unrelated to the customer or product being ordered) based upon the received order data and control parameters to produce an adjustment schedule comprising a one or more promotions. Analysis is then performed on the retrieved adjustment schedule to identify possible up-sell opportunities. This analyzes the available promotions of the adjustments schedule in light of the customer attributes, e.g., by looking at the season, customer identity or group affiliations, item quantity, etc. The up-sell opportunities in the schedule may include both preferred item up-sells as well as quantity increase up-sells. Such opportunities include, for example, pricing discounts for quantity orders or potential order additions for the customer to quality for basket and order level adjustments (e.g., free shipping based on order total, purchase another item to receive a package deal, a reduced price based upon a quantity of an item ordered). For example, if a particular promotion contains quantity breaks for a particular item at 5, 10, and 15, and the customer's current order is for 8 of the item, then up-sell opportunities for a quantity increase up to 10 or 15 may be identified.

The up-sell content is then configured into UI data at 205. This may include creating one or more display areas in the UI corresponding to different types of up-sell opportunities (“preferred items” or “quantity increase”). The UI data may specify a number of up-sell opportunities to be displayed, as well as what attributes of the up-sell opportunities are displayed. The UI data is then displayed to the user on the user interface at 206.

FIG. 2B illustrates the components for performing filtering and analysis on promotions data in order to identify applicable promotions and upsell opportunities in accordance with some embodiments. In order to perform analysis on an adjustment schedule retrieved from promotions data 111, an up-sell analysis module 106 receives data from order data 210 and customer data 212.

Order data 210 comprises data for the particular order for which upsell opportunities are to be generated. In some embodiments, order data 210 is extracted from one or more inputs entered by a CSR at a user interface of an enterprise application, and may include attributes such as a customer identity, items being ordered, quantities for items ordered, item prices, and/or the date/season of the order.

A customer specified in order data 210 may be used by up-sell analysis module 106 to identify the customer data 212 that is to be retrieved. Customer data 212 comprises information concerning the particular customer placing the order, and may include attributes such as customer name/ID, size, type, location, and/or other criteria that may be used for grouping customers.

Control parameters 214 are used by up-sell analysis engine 106 to determine which attributes of order data 210 and customer data 212 to retrieve, as well as how order data 210 and customer data 212 are used to analyze promotions data 111. For example, a promotion of promotions data 111 may be directed at a particular customer, a group of customers (e.g., customer sharing a common attribute, such as location), or all customers. Control parameters 214 may specify the scope or granularity of the analysis (e.g., such that only promotions for the specific customer are retrieved, or promotions for customers having certain attributes, or promotions for all customers).

Promotions data 111 comprise a plurality of promotions, which may be stored as records in a data table. In some embodiments, each promotion contains customer eligibility information, product eligibility information, and promotion information. The customer eligibility information determines which customers will be able to take advantage of a particular promotion, and may identify a particular customer, one or more customer attributes required for eligibility (e.g., a promotion directed to customers that are wholesalers (type) and located in New York (location)), or be generally applicable to all customers.

The product eligibility information specifies which products the promotion pertains to, which may be a particular product (e.g., leather gloves), a product group (e.g., all types of gloves), or all products. In some embodiments, product eligibility information may also specify certain attribute requirements, such as quantity of item ordered.

Promotion information specifies the actual details of the promotion. Promotions may include quantity increase promotions (e.g., applying a discount or other benefit when a certain quantity or monetary value of product is ordered), upsell recommendations (e.g., when a customer wants to order a particular product, recommend a preferred version of the product), or general discounts.

FIG. 2C illustrates a flowchart of a process for retrieving upsell content from promotions data 111 in accordance with some embodiments. At 221, order information and customer information are identified or received. In some embodiments, order information is automatically extracted when a CSR enters order details into a user interface of an enterprise application. In addition, a customer identity may be extracted from the identified order information, and used to retrieve a customer record from a customer database. The retrieved customer record contains customer attribute information (e.g., customer name, customer location, groups the customer is associated with, etc.) that can be used to identify promotions the pertain the customer.

A sales order may contain one or more items. At 222, an item of the order is identified. At 223, up-sell content is identified based upon the identified item and customer information. In some embodiments, identifying up-sell content comprises accessing a promotions database and identifying records of the database that match the item and customer. What types of matches are possible may be configured in accordance with one or more up-sell control parameters. For example, customer information may match if the customer is associated with a promotion record, or has attributes matching a combination of customer attributes (e.g., location, size, membership in a pre-specified customer group) associated with the record. The item may match an item associated with the record, or is part of an item group associated with the record. In addition, certain order attributes associated with the item (e.g., quantity of item ordered) may be considered when determining whether a promotion will be returned as an up-sell recommendation. In some embodiments, promotion records are retrieved using a query on the promotions database for records matching the item and customer information.

At 224, if the order contains additional items for which up-sell recommendations are to be generated, the process returns to 222 to identify another item of the order. If there are no additional items, the retrieved up-sell content is returned to be displayed to the CSR at 225.

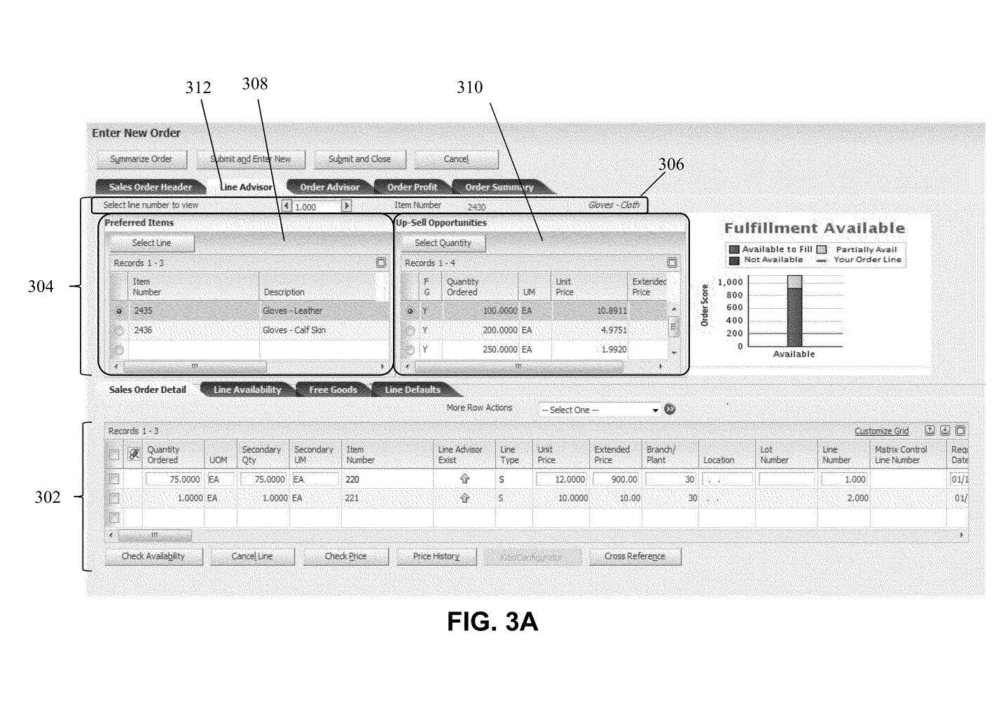

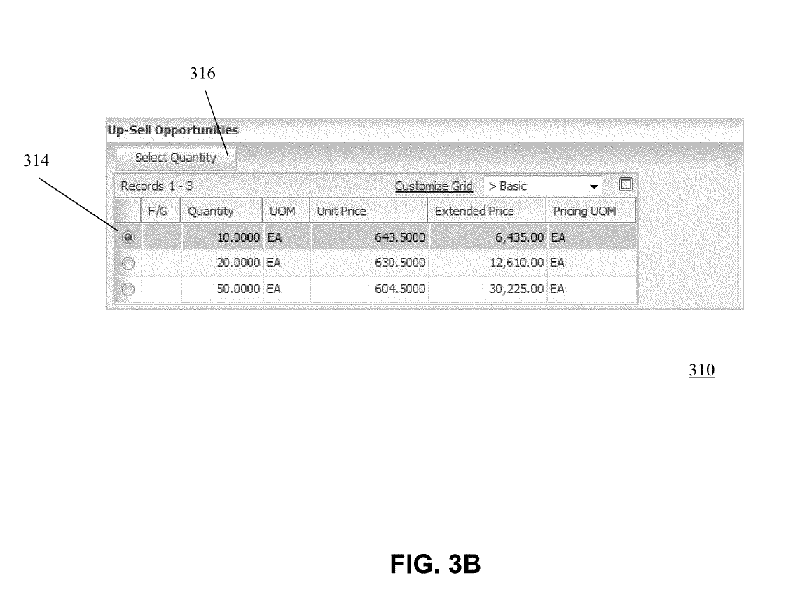

FIG. 3A illustrates a user interface screen 300 that includes the two separate grids containing the preferred item up-sells and the quantity increase up-sells. In user interface screen 300, details for the current order are displayed at 302. The order may be displayed in the form of a table, where each line of the table corresponds to an item ordered. Each line may contain information identifying the item, quantity ordered, item price, etc. Details for up-sell opportunities are displayed at display area 304. In some embodiments, the up-sell opportunities are separated based upon the item for which they were generated for. A control 306 may be used to select a particular item for which to display up-sell opportunities.

In some embodiments, display area 304 is divided into different sections for displaying different types of up-sell opportunities. For example, section 308 shows “preferred item” up-sell opportunities, recommending leather gloves and calf skin gloves in lieu of the ordered product (cloth gloves). On the other hand, section 310 displays “quantity increase” up-sell opportunities, showing different unit prices available for different quantities of cloth gloves.

A tab-based approach may be used that provides a tab onto the main user interface, where selection of the appropriate tab (e.g., tab 312) causes the up-sell interface to be displayed to the user (e.g., at display are 304).

FIG. 3B illustrates a display area 310 for quantity up-sell opportunities in accordance with some embodiments. The user may select a line 314 corresponding to a displayed quantity up-sell. The “Select Quantity” button 316 allows the user to place the quantity given on the selected line 314 onto the order from this interface screen. Similar techniques may be used to allow easy placement/substitution of a preferred up-sell item displayed in display area 308 for an ordered item displayed in displayed area 302.

### Cross-Sell

In some embodiments, a cross-selling analysis process produces at least two components that can be displayed in the user interface, e.g., in two separate grid displays.

The first component is the “Suggested Items” component, which enable the user to view the top n items that were ordered in the past based on count (e.g., top 5 items). This type of search can be performed within the historical sales data by any suitable criteria, such as item, customer, customer group, and/or time frame.

The second component is the “Trending Items” component, which enables the user to look at history and a time period to determine which items are trending (e.g., seasonal). For this component, one can determine how many years of historical data to search, determine time periods to search (e.g., a particular month or season), and/or specify criteria for the scope of analysis (e.g., customer, customer groups, etc.).

As a practical matter, the items in the list should not already exist on the sales order. The user interface is configured to allow the CSR to view various information for the cross-sell opportunities, such as item, description, price, and why the item is displayed (suggestion or trend). Any suitable number of items can be displayed in the grid, e.g., with up to 10 items in the grid.

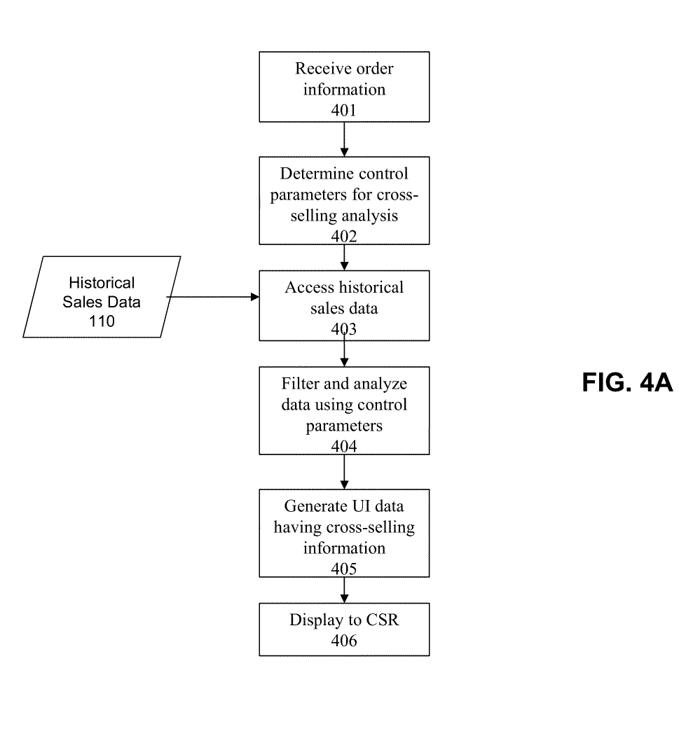

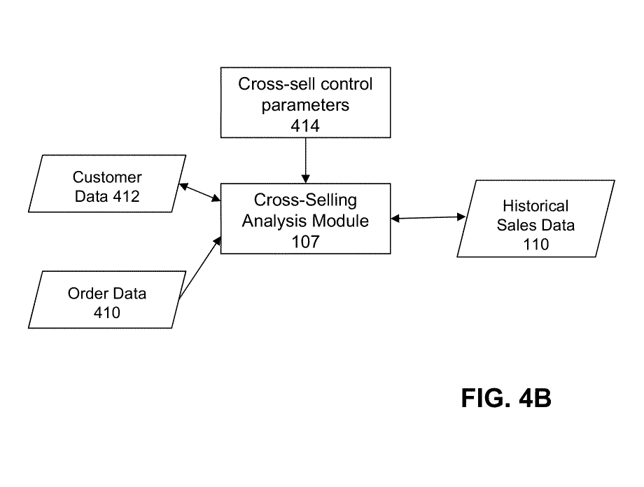

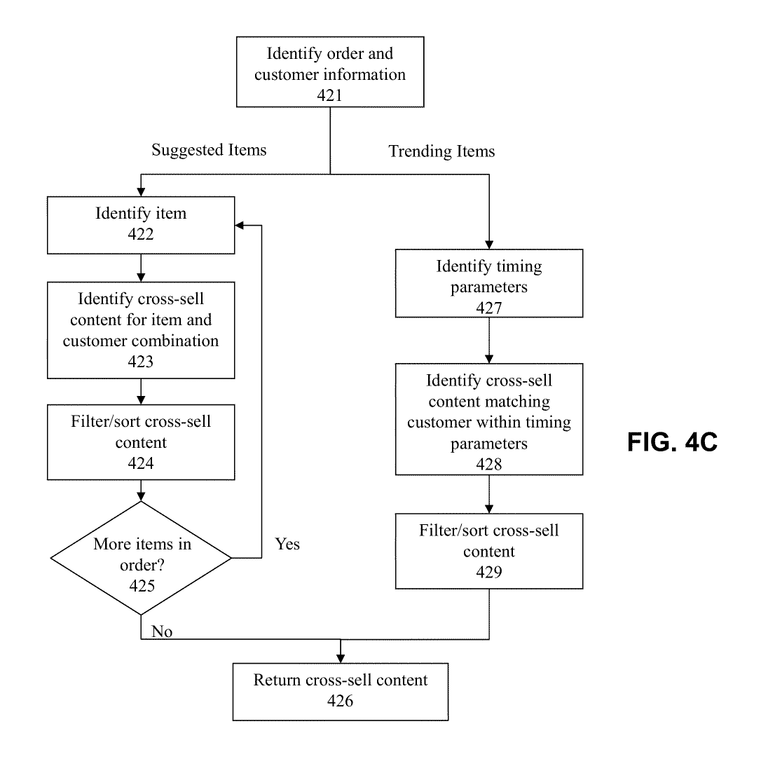

FIG. 4A shows a flowchart of an approach to implement the cross-sell analysis. At 401, the process receives information about the order when the CSR during sales order entry. The entered information that is retrieved may include, for example, item prices, and quantity information.

At 402, control parameters for the cross-sell analysis that is to be performed are received. As with the up-sell analysis, this similarly permits the cross-sell analysis a high level of customization regarding the analysis that is performed. For example, the scope of consideration can be adjusted to any level of granularity with regards to the entity, customer, or group of entities under consideration. Therefore, the analysis can be performed with respect to an individual customer, for a group of customers, or for applicability to everyone. Various ways can be implemented to define the scope of coverage for the analysis, which can be used to implement criteria to filter possible opportunities for display. Examples of such criteria include: (a) geography or region; (b) industry type; (c) customer type (e.g., wholesaler, retailer, distributor, etc.); (d) customer size. Groupings can also be defined to include one or more customers, e.g., by configuring a distribution group or group ID that is common to a group of customers.

Thus, in some embodiments, different cross-sell recommendations may be retrieved for different customers, depending upon different attributes used to define the scope of coverage for the analysis. For example, if the control parameters specify customer location as a criterion for the scope of analysis, a customer located in New York may receive different cross-sell recommendations from a customer in California, due to the scope of analysis for each customer being different, even if the actual items ordered by the two customers are the same.

At 403, a database of historical sales data 110 is accessed, which may contain data records for previously processed sales orders. Each order record of the historical sales data 110 may comprise order information similar to order information 210 described above, such as the customer the placed the order, products ordered, order date, product price/quantity, etc.

At 404, the received data is filtered to remove any inapplicable content. For example, in accordance with the control parameters, historical sales data 110 may be filtered by customer, customer group, or customer attributes. Historical sales data 110 may also be filtered by date, such that only sales orders within a specified time period are analyzed. Analysis is then performed on the historical sales data 110. For example, for an item on the current sales order, counts can be performed to identify the number of times other items have historically been ordered in conjunction with that item. Sorting may be performed to identify the top n items that have been ordered in conjunction with the item(s) in the current sales order. Information about these items forms the basis of the cross-sell content to be displayed to the user.

The cross-sell content is then configured into UI data at 410, which is displayed to the user on the user interface at 412.

FIG. 4B illustrates the components for performing filtering and analysis on the historical data in order to identify cross-sell opportunities. In order to perform cross-selling analysis, a cross-selling analysis module 107 receives data from order data 410 and customer data 412.

Order data 410 comprises data for the particular order for which cross-sell opportunities are to be generated. In some embodiments, order data 420 is extracted from one or more inputs entered by a CSR at a user interface of an enterprise application. Order data 420 may include attributes such as a customer identity, ordered items, item quantities, item prices, and/or the date/season of the order.

Order data 410 may be used by cross-sell analysis module 107 to identify the customer data 412 to be retrieved. Customer data 412 comprises information concerning the particular customer placing the order, and may include attributes such as customer name/ID, size, type, location, and/or other criteria that may be used for grouping customers.

Control parameters 414 may be used by cross-sell analysis engine 107 to determine which attributes of order data 410 and customer data 12 to retrieve, as well as how order data 410 and customer data 412 are used to analyze historical sales data 110. For example, cross-sell control parameters 414 may specify the scope or granularity of the analysis (e.g., only analyze historical sales data for the specific customer, or historical sales data to customers having certain common attributes). In addition, control parameters 414 may specify a analysis time period (e.g., analyze historical sales data from the previous six months, one year, etc.).

Historical sales data 110 comprises records of previously received sales orders. In some embodiments, each sales order record is associated with a customer, and specifies the items ordered. Additional information, such as order date or item pricing, may also be stored in historical sales data 110.

FIG. 4C illustrates a flowchart of a process for retrieving cross-sell content from historical sales data 110 in accordance with some embodiments. At 421, order information and customer information are identified or received. In some embodiments, order information is automatically extracted when a CSR enters order details into a user interface of an enterprise application. In addition, a customer identity may be extracted from the identified order information, and used to retrieve a customer record from a customer database. The customer information may contain a plurality of customer attributes that may be used to identify relevant historical sales data.

In addition, cross-sell control parameters may be identified or received. In some embodiments, the control parameters may be a set of default parameters. In some embodiments, the CSR may specify parameters at a user interface (e.g., during or after entering order information). The control parameters may specify an analysis time period and an analysis granularity.

If “suggested items” cross-sell recommendations are to be generated, the process proceeds to 422, where an item of the order is identified. “Suggested items” cross-sell recommendations are used to recommend products that are frequently ordered by the customer or related customers (as specified by the control parameters) in conjunction with the identified item.

At 423, cross-sell content is identified based upon the identified item and customer information. In some embodiments, a database containing historical sales data is accessed and sales order records that contain the item are retrieved. The sales order records retrieved may also be limited based on customer information, as defined in the cross-sell control parameters. For example, in some cases all historical sales orders containing the item are analyzed to find the products most frequently ordered with the particular item across all customers, while in other cases it may be desirable to restrict the analysis to orders placed by customers related to the current customer (e.g., having common attributes, or part of a same customer group). In some cases, only historical orders for the particular customer are analyzed in order to find out what other items the particular customer has frequently ordered with the particular item. Retrieving the cross-sell content may comprise running a query on the historical sales data with the appropriate item and customer parameters.

At 424, the retrieved historical sales order data is analyzed to determine the most frequently ordered items. In some embodiments, a plurality of item counts are maintained in order to tally in how many of the retrieved orders an item appears. The item counts may then be sorted, and a top n products identified. In some embodiments, any items that already appear in the current order are not counted, so that only items not part of the current order are recommended. In an alternate embodiment, the quantity of items ordered is counted, instead of the number of orders the item appears in.

At 425, if the order contains additional items for which cross-sell recommendations are to be generated, the process returns to 422 to identify another item in the order. If there are no additional items, the retrieved cross-sell content is returned to be displayed to the CSR at 226.

On the other hand, if “trending items” cross-sell recommendations are to be generated, the process proceeds to 427. “Trending item” recommendations are used to identify items that are popular during particular seasons or time periods. At 427, timing parameters are identified. The timing parameters may have been included with the control parameters identified at 421. The timing parameters identify how far back in time the historical sales data is to be analyzed, and also may specify a trending time period. For example, the timing parameters may specify that historical sales data up to three years back in time will be analyzed, with the trending time period being the current month. Thus, if the current month is February, then historical sales data during February of the past three years is analyzed.

At 428, cross-sell content is identified based upon the identified customer information and timing information. In some embodiments, a database containing historical sales data is accessed and sales order records that fall within the time periods specified by the timing parameters are retrieved. The sales order records retrieved may also be limited based on customer information, as defined in the cross-sell control parameters. Retrieving the cross-sell content may comprise running a query on the historical sales data with the appropriate timing and customer parameters. One method for retrieving and identifying cross-sell trending items information is disclosed in U.S. patent application Ser. No. 14/248,225, titled “Method and System for Performing Analysis of Item Order Frequency,” filed on even date herewith, which is hereby incorporated by reference in its entirety.

At 429, the retrieved historical sales order data is analyzed to determine the most frequently ordered items. In some embodiments, a plurality of item counts are maintained in order to tally in how many of the retrieved orders an item appears. The item counts may then be sorted, and a top n items identified. In some embodiments, any items that already appear in the current order are not counted, so that only items not part of the current order are recommended. The analyzed data may then be displayed to the CSR at 426.

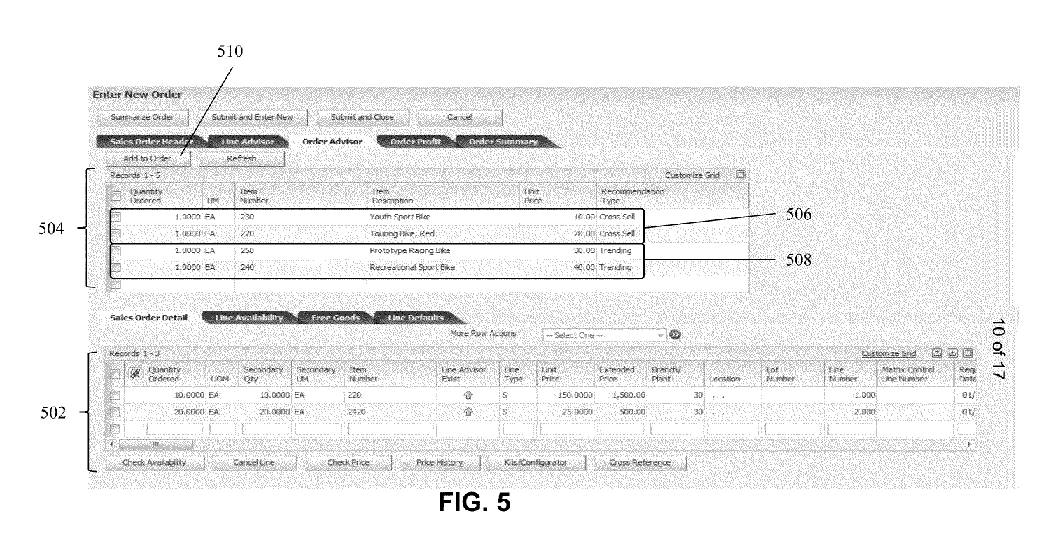

FIG. 5 illustrates a user interface screen 500 that includes the two separate grids containing the suggested items and trending items components. In user interface screen 500, details for the current order are displayed at 502. The order may be displayed in the form of a table, where each line of the table corresponds to a product ordered. The table may contain information for the item, quantity ordered, item price, etc. Details for cross-sell opportunities are displayed at display area 504. The type of cross-sell opportunity (“cross sell” or “trending”) may be displayed for each cross-sell opportunity. For example, opportunity 506 is a suggested item cross-sell opportunity, while 508 is a trending item cross-sell opportunity. An “Add to Order” button 510 may be used to easily add a selected cross-sell item displayed in display area 504 to the current order displayed at 502.

### Dynamic Allocation

The problem addressed by the dynamic allocation analysis module is that there may be many competing orders for a limited number of items in inventory. Therefore, processing is performed in the system in real-time to determine the probability of an item on the sales order getting allocated from inventory. Providing this information to a CSR promotes a more positive customer order experience, since the CSR can now immediately provide more accurate and detailed information about availability for and items, as well as its likelihood of being shipped on a timely basis.

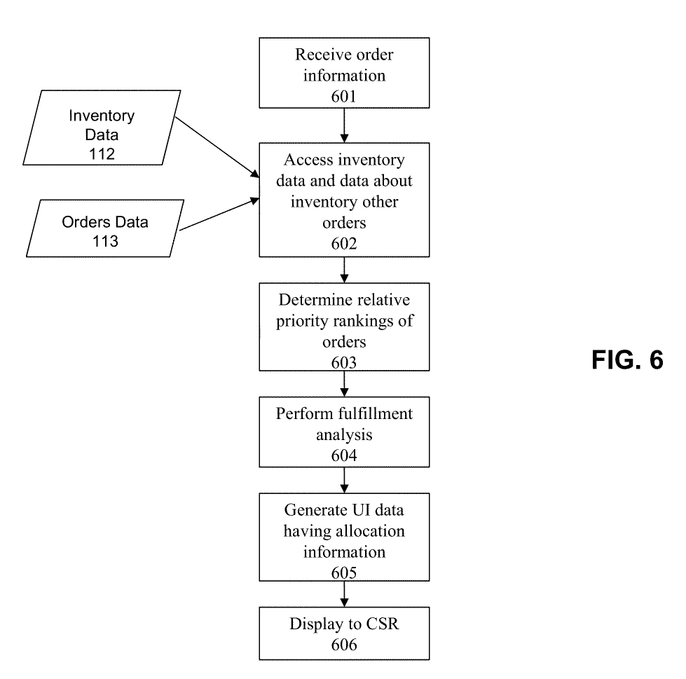

FIG. 6 shows a flowchart of a process for performing the dynamic allocation analysis and display according to some embodiments. At 601, information is provided about the order during order entry by the CSR. This information includes, for example, details about the customer identity and the items being ordered. At 602, the database is accessed to obtain information about other pending orders and about inventory levels.

In many companies, orders may not necessarily be fulfilled on a first in first out basis. Instead, priority rankings may be applied such that certain orders have higher priorities relative to other orders. Therefore, at 603, the process will perform analysis to determine the relative rankings of the current order relative to the rankings of the other pending orders. In some embodiments, a score is calculated for each sales order, wherein sales orders having better scores have higher priority and are fulfilled before orders having lower priority.

Various factors may be used by an allocation analysis module 108 to calculate a sales order priority score. These factors may include an order type, a customer priority, a requested date priority, and custom functions.

A CSR or system administrator may specify a plurality of different order types, wherein different order types will have a different order priority. Order type may be entered by a CSR at an enterprise application. In other embodiments, an order type may automatically be determined based upon items ordered, quantity ordered, or other factors specified by an enterprise application user.

In some embodiments, each customer is associated with a customer priority. The customer priority may be entered by a CSR or system administrator at an enterprise application. In addition, a customer's priority may be based upon various customer attributes, such as customer size, type, location, order history, and/or membership in a preferred customer group.

Requested date priority may be based upon a requested order fulfillment date. In some embodiments, orders with an earlier requested order fulfillment date have a higher requested date priority. In some embodiments, orders for which the requested fulfillment date has passed may be given the highest priority.

In addition, zero or more custom functions may be defined by a CSR or system administrator based upon any criteria deemed relevant.

A weighted sum of the different factors may be used to determine the priority of the sales order. In some embodiments, some priority factors may take precedence over other factors. For example, it may be desired for all orders of a certain type to be given higher priority than all orders of other types, regardless of customer or requested date priority.

At 604, fulfillment analysis can then be performed to determine whether, in light of inventory levels and relative priority rankings, the current order is likely to be backordered or whether it is available for immediate fulfillment. In some embodiments, the order may be assigned a status of a plurality of different statuses (e.g., “high probability of fulfillment,” “moderate probability of fulfillment,” “low probability of fulfillment”). The status of an order may be determined based upon its position in the priority rankings compared to an available inventory. For example, if the total quantity of items in the current order and orders having higher priority exceeds the current available inventory, then the order may be assigned a “low probability” status, while if the quantity is less than a specified number or percentage (e.g., 40%) of the current available inventory, a “high probability” status is assigned. If the quantity is higher than the specified percentage but lower than the available inventor, then a “moderate probability” status may be assigned.

The analysis content is then configured into UI data at 605, which is then displayed to the user on the user interface at 606. Therefore, during order entry, the user will be able to view the probability of an item on the sales order getting inventory allocated.

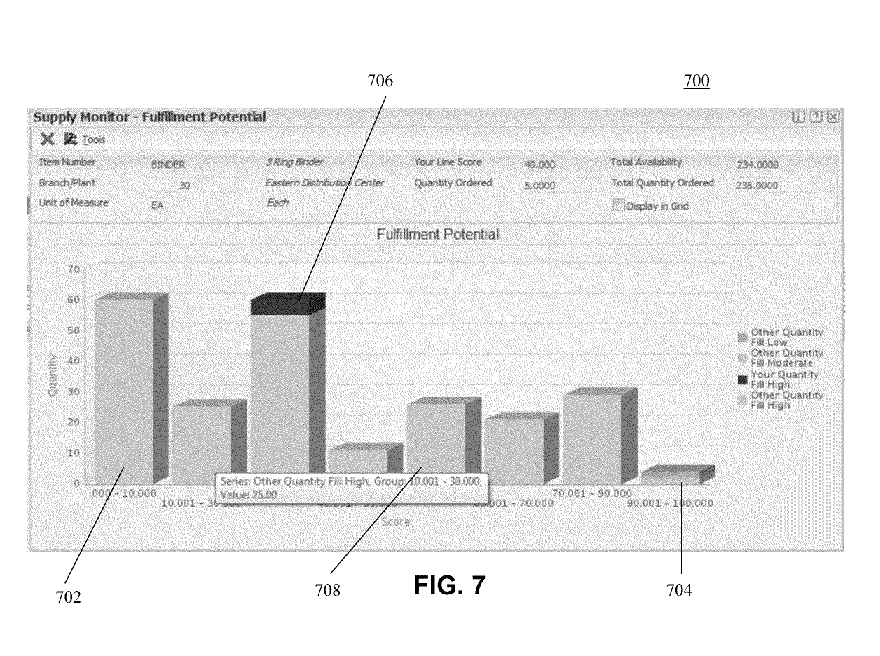

FIG. 7 illustrates an example bar chart that may be displayed in a user interface screen for visualizing inventory levels (e.g., available vs. open commitments) and the priority ranking of the current sales order line. For example, in the illustrated example, bar chart 700 contains a plurality of bars corresponding to different priority score ranges, where a lower score corresponds to higher priority. For example, bar 702 corresponds to sales orders that have the highest priority and thus a high probability of fulfillment, while bar 704 corresponds to sales orders with the lowest priority and thus moderate to low probability of fulfillment. The priority of the current order relative to other currently pending orders is shown in bar 706. The cutoff between orders having different fulfillment status (e.g., “high” and “moderate”) may be configured by a user. In chart 700, this is illustrated at bar 708.

### Profit Data Display

The additional content to present to the CSR can also be used to enhance profitability of the sales transactions. It is obvious that product sales must be profitable to keep a company in business. To facilitate consummation of more profitable orders (rather than less profitable orders), it is helpful to be able to display profit analysis for the order to the CSR. This provides insight into the impact of changing sales conditions to the company's bottom line and to enable knowledgeable decision making. One method for simulating profitability for sales orders disclosed in U.S. patent application Ser. No. 14/247,754, titled “Profitability Simulator,” filed on even date herewith, which is hereby incorporated by reference in its entirety.

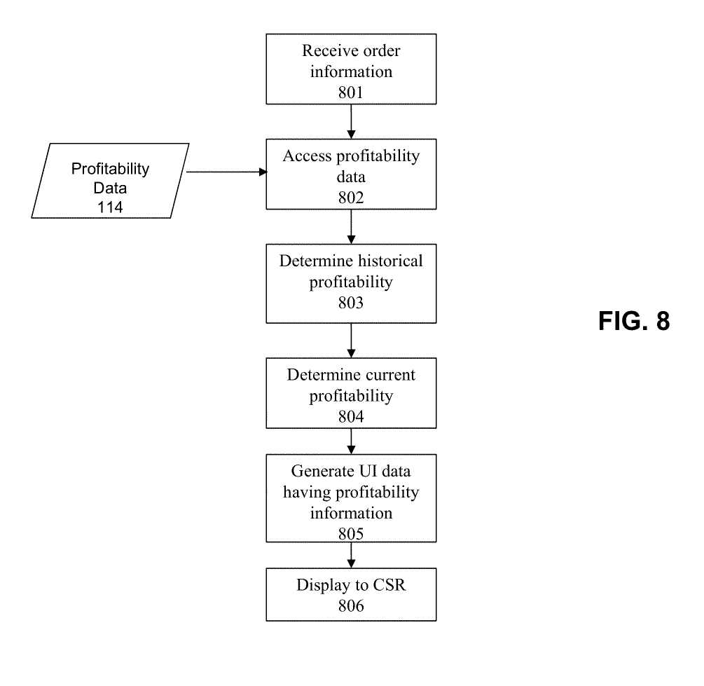

FIG. 8 illustrates a flowchart to perform the profit analysis and display in accordance with some embodiments. At 801, information is provided about the order during order entry by the CSR. This information includes, for example, details about the items being ordered, pricing for the items, and order quantities.

At 802, the database is accessed to obtain profitability information. This information may include historical sales data 110 as well as profitability data 114 about the specific items currently being ordered.

At 803, historical profitability information is determined, e.g., to identify the historical average profit margins or the trends of the profit margins over time. In some embodiments, the each historical sales orders stored in historical sales data 110 contains profitability information for that order. Historical sales data 110 is queried to retrieve all orders by the customer over a specified time period. In some embodiments, historical sales orders by related customers may be retrieved as well, wherein the scope or granularity of the analysis may be defined by one or more control parameters. Profitability information is extracted from the retrieved sales order, from which a historical average profit margin may be calculated.

Because historical sales data 110 may be very large and store thousands of sales orders, queries upon the historical sales data in order to determine profitability information may be very time-consuming. For this reason, many traditional approaches are not implemented with the capability of performing profitability analysis in real time. One method for improving the efficiency of performing such queries is disclosed in U.S. patent application Ser. No. 14/247,993, titled “Method and System for Implementing an On Demand Data Warehouse,” filed on even date herewith, which is hereby incorporated by reference in its entirety.

At 804, the profit margin of the current order is determined. This determination can be used to calculate an overall profit margin for the current order, as well as the profit margins for the individual items in the current order. In some embodiments, this may be done by querying profitability data 114 to retrieve profitability information for the items in the current order, which may then be aggregated based upon the quantity of items ordered to determine an overall profit margin of the current order.

At 805, the analysis content is then configured into UI data, which is then displayed to the user on the user interface at 806. Therefore, during order entry, the user will be able to view profitability information in the user interface.

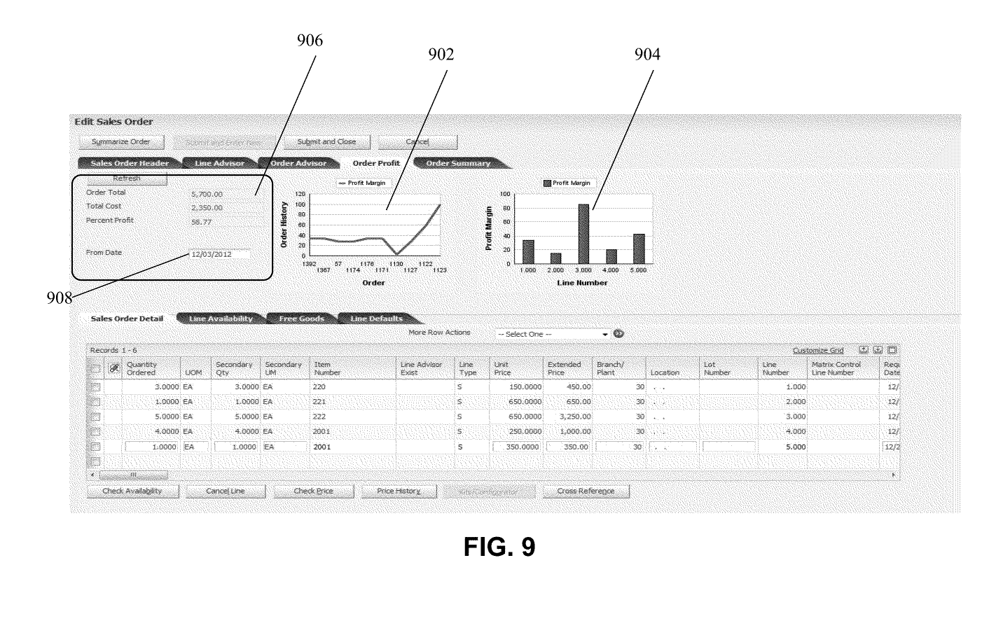

FIG. 9 illustrates an example user interface screen that can be used to provide this profitability information. The interface includes a tab in the interface which includes various charts (902 and 904) that provide the profitability information, along with details about the current order (e.g., order total, total order cost, and total percent profit) at display area 906. A control 908 may be used to specify a date or date range for which profitability is to be calculated and displayed.

In the illustrated embodiment, chart 902 shows a graph of profit margins for past sales orders for the customer, allowing a CSR to determine how the profitability of the current order compares. On the other hand, chart 904 shows the profit margins for each line item of the current order, with each bar representing a line item.

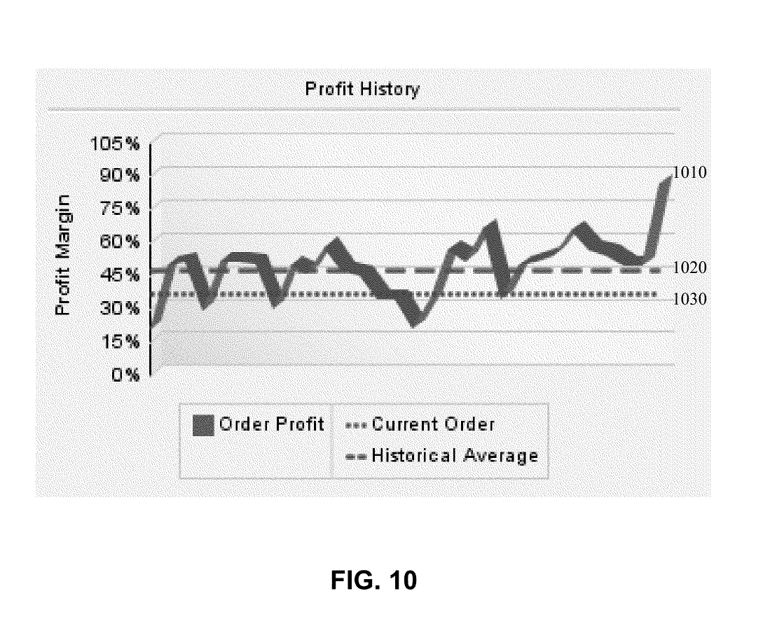

FIG. 10 illustrates an example Customer Profit Margin graph which displays the profit margin for the customer's previous orders using the time frame specified by the user (e.g., as a historical average profit margin and/or the trends of the profit margins for past sales over the time period). A line graph 1010 may be used to display the profit margins the customer's previous orders, while an average historical profitability may be calculated and displayed has a horizontal line 1020. This chart can also display the current order profit margin level as a line 1030, allowing for the CSR to easily compare the profitability of the current order with the average historical profitability.

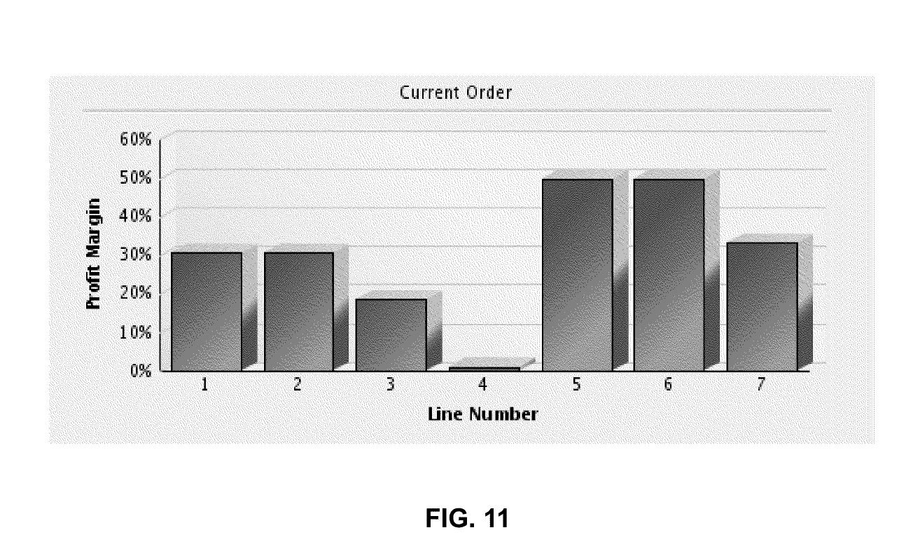

FIG. 11 illustrates an example Line Profit Margin graph which displays the profit margin for each line on the current sales order using the existing profit margin data for each line, allowing for the CSR to easily identify which line items in the order are generating the highest profitability, and which are generating the lowest.

Therefore, what has been described is an improved approach for performing analysis and display of revenue opportunities for large data sets. A user interface is provided to the CSR which provides real-time data relevant to the sales process. The information includes, for example, up-selling opportunities, cross-selling opportunities, profitability analysis, and/or fulfillment analysis. The analysis can be performed with controllable levels of granularity and specificity for the analysis.

This approach advantageously provides visibility into real-time product suggestions during the sales order entry process, which gives the CSR information to drive additional sales for his/her company. With CSRs up-selling and cross-selling during order entry, both sales volumes and revenue are likely to increase.

In addition, insight into large volumes data in real-time enables CSRs to leverage sales opportunities and proactively adapt to changing sales conditions during order capture. The large volume of data is compiled, summarized, and displayed for the CSR to make recommendations to the customer very quickly, instead of using error prone, manual processes to locate information which takes excessive amounts of time and can require return calls to the customer. As a result, enterprises can increase the efficiency of the order entry process, create and enhance up-sell and cross-sell revenue opportunities, and reduce error prone manual tasks and dissatisfied customers.

### System Architecture Overview

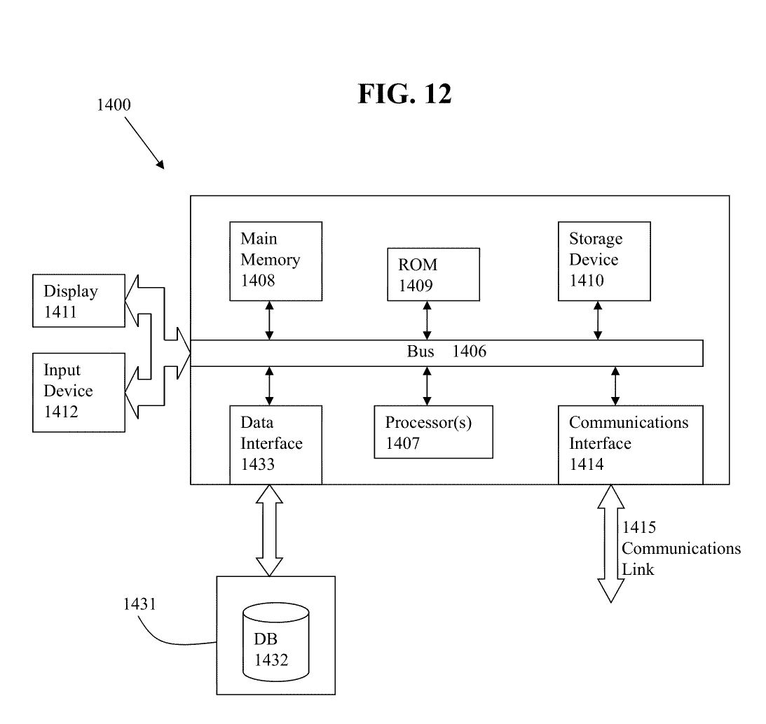

FIG. 12 is a block diagram of an illustrative computing system 1400 suitable for implementing an embodiment of the present invention. Computer system 1400 includes a bus 1406 or other communication mechanism for communicating information, which interconnects subsystems and devices, such as processor 1407, system memory 1408 (e.g., RAM), static storage device 1409 (e.g., ROM), disk drive 1410 (e.g., magnetic or optical), communication interface 1414 (e.g., modem or Ethernet card), display 1411 (e.g., CRT or LCD), input device 1412 (e.g., keyboard), and cursor control.

According to one embodiment of the invention, computer system 1400 performs specific operations by processor 1407 executing one or more sequences of one or more instructions contained in system memory 1408. Such instructions may be read into system memory 1408 from another computer readable/usable medium, such as static storage device 1409 or disk drive 1410. In alternative embodiments, hard-wired circuitry may be used in place of or in combination with software instructions to implement the invention. Thus, embodiments of the invention are not limited to any specific combination of hardware circuitry and/or software. In one embodiment, the term “logic” shall mean any combination of software or hardware that is used to implement all or part of the invention.

The term “computer readable medium” or “computer usable medium” as used herein refers to any medium that participates in providing instructions to processor 1407 for execution. Such a medium may take many forms, including but not limited to, non-volatile media and volatile media. Non-volatile media includes, for example, optical or magnetic disks, such as disk drive 1410. Volatile media includes dynamic memory, such as system memory 1408.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In an embodiment of the invention, execution of the sequences of instructions to practice the invention is performed by a single computer system 1400. According to other embodiments of the invention, two or more computer systems 1400 coupled by communication link 1415 (e.g., LAN, PTSN, or wireless network) may perform the sequence of instructions required to practice the invention in coordination with one another.

Computer system 1400 may transmit and receive messages, data, and instructions, including program, i.e., application code, through communication link 1415 and communication interface 1414. Received program code may be executed by processor 1407 as it is received, and/or stored in disk drive 1410, or other non-volatile storage for later execution.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

What is claimed is:

1. A computer implemented method implemented with a processor, comprising:
receiving data for a sales order corresponding to a customer entity and comprising item information;
performing real-time analysis of the sales order, in which the real-time analysis comprises at least one of up-sell analysis or cross-selling analysis, wherein:
performing up-sell analysis comprises:
identifying up-sell control parameters specifying one or more customer entity attributes for the up-sell analysis;
accessing promotions data;
identifying up-sell opportunities for the sales order using the accessed promotions data, based at least in part upon the up-sell control parameters;
wherein, based at least in part upon the up-sell control parameters, the up-sell opportunities identified for a first sales order corresponding to a first customer entity may be different from those identified for a second sales order corresponding to a second customer entity, even though the first sales order and the second sales order correspond the same item information; and
performing cross-sell analysis comprises:
identifying one or more cross-sell control parameters specifying one or more customer entity attributes for the cross-sell analysis;
accessing historical sales data;
identifying cross-sell opportunities for the sales order using the historical sales data, based at least in part upon the cross-sell control parameters;
wherein, based at least in part upon the cross-sell control parameters, the cross-sell opportunities identified for a first sales order corresponding to a first customer entity may be different from those identified for a second sales order corresponding to a second customer entity, even though the first sales order and the second sales order correspond the same item information; and
generating analysis data to be displayed to a customer service representative on a display device.

2. The method of claim 1, wherein the analysis data is displayed on a tabbed interface, wherein the data for the sales order is presented on a first tab and the analysis data is presented on a second tab.

3. The method of claim 1, in which the one or more attributes of the customer entity includes entity, entity group, geography, region, industry type, customer type, or customer size.

4. The method of claim 1, wherein identifying up-sell opportunities comprises filtering the promotions data, based at least in part upon the item information and the one or more specified customer entity attributes of the customer entity.

5. The method of claim 1, in which the up-sell analysis analyzes for at least one of preferred item opportunities or quantity increase opportunities.

6. The method of claim 1, in which the historical sales data is filtered for applicability, based at least in part upon the one or more specified customer entity attributes of the customer entity.

7. The method of claim 6, wherein identifying cross-sell opportunities comprises identifying frequently ordered items based at least in part upon the filtered historical sales data.

8. The method of claim 1, in which the cross-sell analysis analyzes for at least one of suggested item opportunities or trending item opportunities, wherein the suggested item opportunities comprises a list of top n items that were ordered by a set of customer entities in a specified time period based on count, wherein the set of customer entities and specified time period are based at least in part upon the one or more cross-sell control parameters.

9. The method of claim 1, in which performing real-time analysis of the sales order further comprises allocation analysis, wherein the allocation analysis is performed with a process comprising:
accessing inventory data and orders data;
determining relative rankings the current order to the rankings of other pending orders; and
performing fulfillment analysis using the inventory data and the orders data.

10. The method of claim 9, in which the fulfillment analysis determines whether, in light of inventory levels and relative priority rankings, the current order is likely to be backordered or whether be available for immediate fulfillment.

11. The method of claim 9, in which a user interface comprises a bar chart that visualizes inventory levels and the priority ranking of the current sales order.

12. The method of claim 1, in which performing real-time analysis of the sales order further comprises performing profitability analysis, wherein the profitability analysis is performed with a process comprising:
identifying one or more profitability control parameters specifying a granularity for scope consideration of the profitability analysis
accessing profitability data;
determining historical profitability based at least in part upon the one or more profitability parameters; and
determining current profitability for the sales order based at least in part upon the profitability data.

13. The method of claim 14, in which a user interface comprises an interface screen that displays the historical profitability and the current profitability for the sales order.

14. A system comprising:
a processor;
a memory comprising computer code executed using the processor, in which the computer code implements a method comprising:
receiving data for a sales order corresponding to a customer entity and comprising item information;
performing real-time analysis of the sales order, in which the real-time analysis comprises at least one of up-sell analysis or cross-selling analysis, wherein:
performing up-sell analysis comprises:
identifying up-sell control parameters specifying one or more customer entity attributes for the up-sell analysis;
accessing promotions data;
identifying up-sell opportunities for the sales order using the accessed promotions data, based at least in part upon the up-sell control parameters;
wherein, based at least in part upon the up-sell control parameters, the up-sell opportunities identified for a first sales order corresponding to a first customer entity may be different from those identified for a second sales order corresponding to a second customer entity, even though the first sales order and the second sales order correspond the same item information; and
performing cross-sell analysis comprises:
identifying one or more cross-sell control parameters specifying one or more customer entity attributes for the cross-sell analysis;
accessing historical sales data;
identifying cross-sell opportunities for the sales order using the historical sales data, based at least in part upon the cross-sell control parameters;
wherein, based at least in part upon the cross-sell control parameters, the cross-sell opportunities identified for a first sales order corresponding to a first customer entity may be different from those identified for a second sales order corresponding to a second customer entity, even though the first sales order and the second sales order correspond the same item information; and
generating analysis data to be displayed to a customer service representative on a display device.

15. The system of claim 14, wherein the analysis data is displayed on a tabbed interface, wherein the data for the sales order is presented on a first tab and the analysis data is presented on a second tab.

16. The system of claim 14, in which the one or more attributes of the customer entity includes entity, entity group, geography, region, industry type, customer type, or customer size.

17. The system of claim 14, wherein identifying up-sell opportunities comprises filtering the promotions data, based at least in part upon the item information and the one or more specified customer entity attributes of the customer entity.

18. The system of claim 14, in which the up-sell analysis analyzes for at least one of preferred item opportunities or quantity increase opportunities.

19. The system of claim 14, in which the historical sales data is filtered for applicability, based at least in part upon the one or more specified customer entity attributes of the customer entity.

20. The system of claim 19, wherein identifying cross-sell opportunities comprises identifying frequently ordered items based at least in part upon the filtered historical sales data.

21. The system of claim 14, in which the cross-sell analysis analyzes for at least one of suggested item opportunities or trending item opportunities, wherein the suggested item opportunities comprises a list of top n items that were ordered by a set of customer entities in a specified time period based on count, wherein the set of customer entities and specified time period are based at least in part upon the one or more cross-sell control parameters.

22. The system of claim 14, in which performing real-time analysis of the sales order further comprises allocation analysis, wherein the allocation analysis is performed with a process comprising:
accessing inventory data and orders data;
determining relative rankings the current order to the rankings of other pending orders; and
performing fulfillment analysis using the inventory data and the orders data.

23. The system of claim 22, in which the fulfillment analysis determines whether, in light of inventory levels and relative priority rankings, the current order is likely to be backordered or whether be available for immediate fulfillment.

24. The system of claim 22, in which a user interface comprises a bar chart that visualizes inventory levels and the priority ranking of the current sales order.

25. The system of claim 14, in which performing real-time analysis of the sales order further comprises performing profitability analysis, wherein the profitability analysis is performed with a process comprising:
identifying one or more profitability control parameters specifying a granularity for scope consideration of the profitability analysis
accessing profitability data;
determining historical profitability based at least in part upon the one or more profitability parameters; and
determining current profitability for the sales order based at least in part upon the profitability data.

26. The system of claim 25, in which a user interface comprises an interface screen that displays the historical profitability and the current profitability for the sales order.

27. A computer readable medium having stored thereon a sequence of instructions which, when executed by a processor causes the processor to execute a method comprising:
receiving data for a sales order corresponding to a customer entity and comprising item information;
performing real-time analysis of the sales order, in which the real-time analysis comprises at least one of up-sell analysis or cross-selling analysis, wherein:
performing up-sell analysis comprises:
identifying up-sell control parameters specifying one or more customer entity attributes for the up-sell analysis;
accessing promotions data;
identifying up-sell opportunities for the sales order using the accessed promotions data, based at least in part upon the up-sell control parameters;
wherein, based at least in part upon the up-sell control parameters, the up-sell opportunities identified for a first sales order corresponding to a first customer entity may be different from those identified for a second sales order corresponding to a second customer entity, even though the first sales order and the second sales order correspond the same item information; and
performing cross-sell analysis comprises:
identifying one or more cross-sell control parameters specifying one or more customer entity attributes for the cross-sell analysis;
accessing historical sales data;
identifying cross-sell opportunities for the sales order using the historical sales data, based at least in part upon the cross-sell control parameters;
wherein, based at least in part upon the cross-sell control parameters, the cross-sell opportunities identified for a first sales order corresponding to a first customer entity may be different from those identified for a second sales order corresponding to a second customer entity, even though the first sales order and the second sales order correspond the same item information; and
generating analysis data to be displayed to a customer service representative on a display device.

28. The computer program product of claim 27, wherein the analysis data is displayed on a tabbed interface, wherein the data for the sales order is presented on a first tab and the analysis data is presented on a second tab.

29. The computer program product of claim 27, in which the one or more attributes of the customer entity includes entity, entity group, geography, region, industry type, customer type, or customer size.

30. The computer program product of claim 27, wherein identifying up-sell opportunities comprises filtering the promotions data, based at least in part upon the item information and the one or more specified customer entity attributes of the customer entity.

31. The computer program product of claim 27, in which the up-sell analysis analyzes for at least one of preferred item opportunities or quantity increase opportunities.

32. The computer program product of claim 27, in which the historical sales data is filtered for applicability, based at least in part upon the one or more specified customer entity attributes of the customer entity.

33. The computer program product of claim 32, wherein identifying cross-sell opportunities comprises identifying frequently ordered items based at least in part upon the filtered historical sales data.

34. The computer program product of claim 27, in which the cross-sell analysis analyzes for at least one of suggested item opportunities or trending item opportunities, wherein the suggested item opportunities comprises a list of top n items that were ordered by a set of customer entities in a specified time period based on count, wherein the set of customer entities and specified time period are based at least in part upon the one or more cross-sell control parameters.

35. The computer program product of claim 27, in which performing real-time analysis of the sales order further comprises allocation analysis, wherein the allocation analysis is performed with a process comprising:
accessing inventory data and orders data;
determining relative rankings the current order to the rankings of other pending orders; and
performing fulfillment analysis using the inventory data and the orders data.

36. The computer program product of claim 35, in which the fulfillment analysis determines whether, in light of inventory levels and relative priority rankings, the current order is likely to be backordered or whether be available for immediate fulfillment.

37. The computer program product of claim 35, in which a user interface comprises a bar chart that visualizes inventory levels and the priority ranking of the current sales order.

38. The method of claim 1, in which performing real-time analysis of the sales order further comprises performing profitability analysis, wherein the profitability analysis is performed with a process comprising:
identifying one or more profitability control parameters specifying a granularity for scope consideration of the profitability analysis
accessing profitability data;
determining historical profitability based at least in part upon the one or more profitability parameters; and
determining current profitability for the sales order based at least in part upon the profitability data.

39. The computer program product of claim 38, in which a user interface comprises an interface screen that displays the historical profitability and the current profitability for the sales order.
